(19) United States
(12) Patent Application Publication
(10) Pub. No.: US 2014/0339038 A1
(43) Pub. Date: Nov. 20, 2014

(54) LEISURE EQUIPMENT TROLLEY

(71) Applicant: SEAWEST TECHNOLOGIES PTE. LIMITED, The Claymore, Unit 14-03 (SG)

(72) Inventors: Mark Welker, Singapore (SG); Michael Pinnington, Wimborne Dorset (GB); Ben Davies, Lyndhurst Hampshire (GB)

(73) Assignee: SEAWEST TECHNOLOGIES PTE. LIMITED, Singapore (SG)

(21) Appl. No.: 14/352,561

(22) PCT Filed: Oct. 18, 2012
(86) PCT No.: PCT/GB2012/052578

§ 371 Date: Apr. 17, 2014

(30) Foreign Application Priority Data
Oct. 18, 2011 (GB) 1117915.7

(51) Int. Cl. A45C 13/38; B62B 3/12; B62B 3/02

(52) U.S. Cl. CPC A45C 13/385; B62B 3/02; B62B 3/12
USPC 190/18 A; 280/35

(57) ABSTRACT

A leisure equipment trolley includes an elongate base spine aligned with the longitudinal axis of the trolley, at least two rear wheels and one front wheel being mounted on the base spine, and load support means on which a load can be mounted in use. The trolley further includes a collapsible support frame being mounted on the spine and movable from a collapsed condition wherein the support frame is adjacent the spine to an operational condition in which the support frame is upstanding from the spine. The support frame includes two elongate frame members, first ends of which are pivotally connected together, the other end of the first elongate frame member being pivotally mounted to the base spine, the other end of the second elongate frame member being movably mounted on the base spine so as to be moveable along the spine.

The present invention relates to a leisure equipment trolley and particularly but not exclusively relates to a leisure equipment trolley for domestic use.

When taking part in a leisure activity that requires items such as equipment to be carried, it can be difficult or inconvenient to transport those items from one location to the other. This can be particularly troublesome when those items are required for more than once person such as for a family for example.

For example, if the items comprise snow equipment such as skis, ski poles, snowboards, and boots, it can be difficult to transport these from a hotel, chalet, car park, or bus stop to the bottom of the piste, ski lift or cable car. For an average family this could involve transporting multiple pairs of relatively heavy and cumbersome skis, ski poles and boots. It may also or alternatively be required to transport snowboards.

Likewise, there are many other situations where it might be desirable to easily and conveniently transport leisure equipment from a vehicle or store to another location. For example a family picnic typically involves transporting food and seating to the picnic location. When competing in, or spectating at a sports event, it is usually necessary to transport sports equipment and/or refreshments and seating to a sports field, arena or stadium for example.

The present invention stems from some work to provide a leisure equipment trolley that alleviates the above problems.

According to a first aspect of the invention there is provided a leisure equipment trolley comprising an elongate base spine aligned with the longitudinal axis of the trolley. The trolley may comprise at least two rear wheels and one front wheel, which may be mounted on the base spine. It may further comprise a load support means on which a load can be mounted in use. The trolley may further comprise a collapsible support frame being mounted on the spine and movable from a collapsed condition wherein the support frame is adjacent the spine to an operational condition in which the support frame is upstanding from the spine. The support frame may comprise two elongate frame members first ends of which may be pivotally connected together. The other end of the first elongate frame member may be pivotally mounted to the base spine. The other end of the second elongate frame member may be movably mounted on the base spine so as to be moveable along the spine towards and away from the pivotal mounting of the first elongate frame member on the spine such that the support frame can be moved from the collapsed condition to the operational condition and vice versa.

Preferably the trolley further comprises an auto-erect actuator being provided one end of which is fixed to the spine, the other end of which is connected to the support frame, the actuator being operative to exert a driving force on the support frame to drive the second elongate frame member away from the pivot mounting of the front frame tube to raise the support frame to the operational condition.

Preferably the second elongate frame member is mounted on a carriage, the carriage being movably mounted on the base spine for movement along the spine. Most preferably the carriage is slidably mounted on the spine.

Preferably the first and second elongate frame members together form a generally ‘n’ shaped support frame, when in the operational condition.

Preferably at least one of the elongate frame members is arcuate. Preferably the first elongate frame member is arcuate, the second elongate frame member being substantially straight.

Preferably the apex of the ‘n’ shaped support frame comprises a carrying handle suitable for a user to pick up the trolley, when in the collapsed condition.

Preferably the second elongate frame member is arranged to be positioned between the spine and the first elongate frame member, when in the collapsed condition.

Preferably the support frame, when in the operational condition, is upstanding from the centre of the trolley, that is the longitudinal axis of the support frame is coplanar with the longitudinal axis of the trolley.

The auto-erect actuator may be operative to exert a driving force in the form of a biasing force operative to bias the second elongate frame member away from the pivot mounting of the front frame tube.

The auto-erect actuator may comprise a gas strut for example. The auto-erect actuator may comprise a spring.

Preferably each rear wheel is mounted on a respective wing frame, each wing frame extending from a respective side of the spine.

Preferably each wing frame is movably mounted on the spine so as to be movable from a collapsed condition in which each wing frame and rear wheel are adjacent the spine, to an operational condition in which each wing frame extends laterally away from the spine such that each rear wheel is laterally spaced from the spine.

Preferably each wing frame comprises a longitudinally extending arm pivotally mounted to the spine, and a laterally extending strut, one end of which is connected to the arm, the other end of which is movably mounted on the base spine so as to be moveable along the spine towards and away from the pivotal mounting of the front frame tube on the spine to move each wing frame from the collapsed condition to the operational condition and vice versa.

Preferably the auto-erect actuator is operative to move the wing frames from the collapsed condition to the expanded condition.

Preferably the other end of each laterally extending strut is connected to the second elongate frame member of the support frame. Most preferably the other end of each laterally extending strut is connected to the carriage.

Preferably the load support means is provided at the longitudinal axis of the trolley.

Preferably the load support means is retractable, when the trolley is in the collapsed condition.

Preferably the load support means comprises an upper mounting bracket provided on the support frame, a pannier being provided and being adapted to be mounted on the mounting bracket so as to hang down from the bracket.

Preferably the bracket comprises a pair of opposed support bars projecting from the support frame.

Preferably the pannier is a semi-rigid bag, that is, of a flexible material provided with a reinforcing structure.

Preferably the pannier is partitioned so as to form at least two separate compartments. Most preferably the pannier comprises an inclined partition extending between front and rear walls of the pannier such that the pannier is provided with an upper and a lower compartment.

Preferably the load support means alternatively or additionally comprises a load carrying platform adapted to be mounted on the spine.

The load support means may be provided with a load retainer operative to retain the load on the load support means. The load retainer may comprise a strap, tie back or loop for example.

Preferably a handle is provided at the rear of the support frame to enable the trolley to be pushed in use.

Preferably the handle is retractable. Most preferably the handle is pivotally mounted on the second elongate frame member of the support frame so as to be movable from an operational condition in which the handle projects from the support frame, to a collapsed condition in which the handle is adjacent the support frame.

Preferably a latch is provided to lock the trolley in the operational condition.

Preferably latch release means are provided at the handle to release the latch to enable the trolley to be collapsed into the collapsed condition.

Preferably the latch release means comprises a rod that projects from the support frame, one end of the rod engaging the spine when the trolley is in the operational condition.

Preferably the latch release means is operated by moving the handle relative to the support frame.

Preferably the front wheel is removably mounted on the spine.

Preferably the front wheel comprises a wheel mount comprising a mounting plug received in a mounting socket on the spine to mount the front wheel on the spine.

Preferably the mounting socket is provided with a spring loaded movable closure operative to automatically close the mounting socket when the mounting plug is removed from the mounting socket, so as to resist ingress of foreign bodies in the mounting socket, when the wheel is removed.

According to a second aspect of the invention there is provided a snow equipment trolley comprising an elongate base spine aligned with the longitudinal axis of the trolley, at least two rear wheels and one front wheel being mounted on the base spine, and snow equipment support means for carrying snow equipment in use, the snow equipment support means comprising a mounting lug on the support frame, a pannier for at least one of ski boots, snow boots, snowboard boots, or other ski or snowboard equipment, the pannier being adapted to be mounted on the mounting lug so as to hang from the mounting lug, and a load platform mounted on the spine for supporting skis and/or snowboards, the trolley further comprising a collapsible support frame being mounted on the spine and movable from a collapsed condition wherein the support frame is adjacent to the spine to an operational condition in which the support frame is upstanding from the spine, the support frame comprising two elongate frame members first ends of which are pivotally connected together, the other end of the first elongate frame member being pivotally mounted to the base spine, the other end of the second elongate frame member being movably mounted on the base spine so as to be moveable along the spine towards and away from the pivotal mounting of the first elongate frame member on the spine such that the support frame can be moved from the collapsed condition to the operational condition and vice versa.

Preferably the trolley further comprises an auto-erect actuator being provided one end of which is fixed to the spine, the other end of which is connected to the support frame, the actuator being operative to exert a driving force on the support frame to drive the second elongate frame member away from the pivot mounting of the front frame tube to raise the support frame to the operational condition.

According to a third aspect of the invention there is provided removable luggage for mounting on a trolley according to the first or second aspects of the invention.

The present invention further provides a snow equipment trolley comprising a base frame on which are mounted two transversely spaced rear wheels and a steerable front wheel, a support frame upstanding from the base frame, at least one of the base frame and the support frame being provided with ski equipment support means on which ski equipment can be supported in use of the trolley.

Other aspects of the present invention may include any combination of the features or limitations referred to herein.

The invention may further comprise, in any combination, any one or more features of the embodiments which will now be described by way of example only with reference to the accompanying drawings in which:

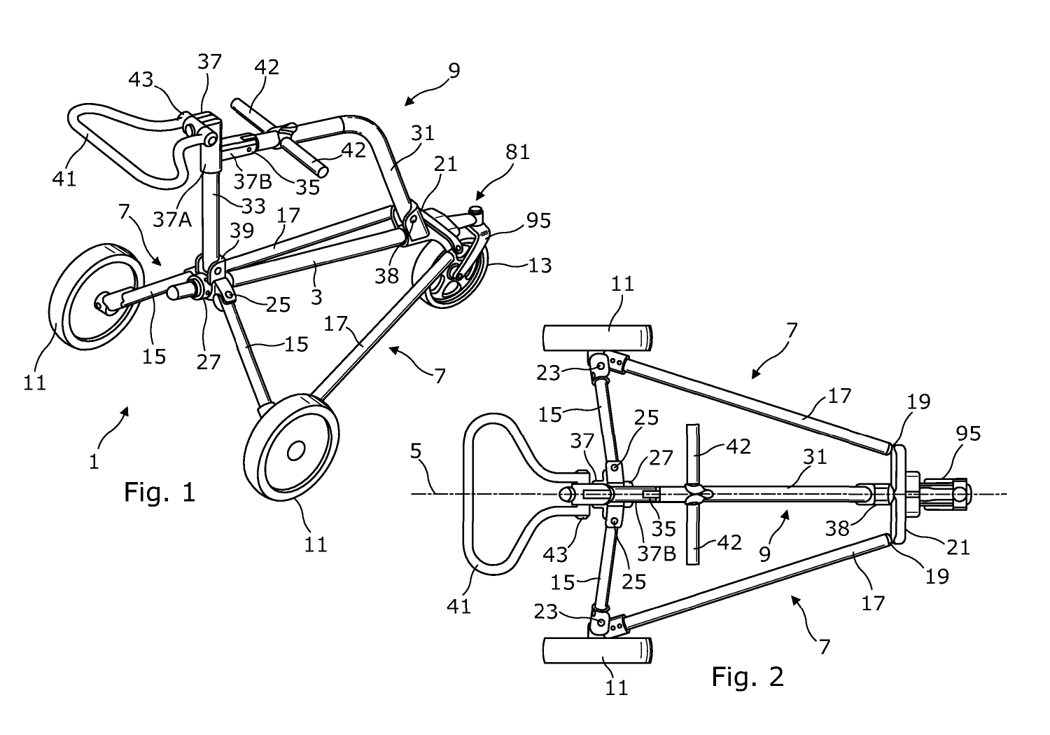

FIG. 1 is a perspective view of a leisure equipment trolley in accordance with the present invention, with the trolley in an operational condition;

FIG. 2 is a plan view of the trolley of FIG. 1;

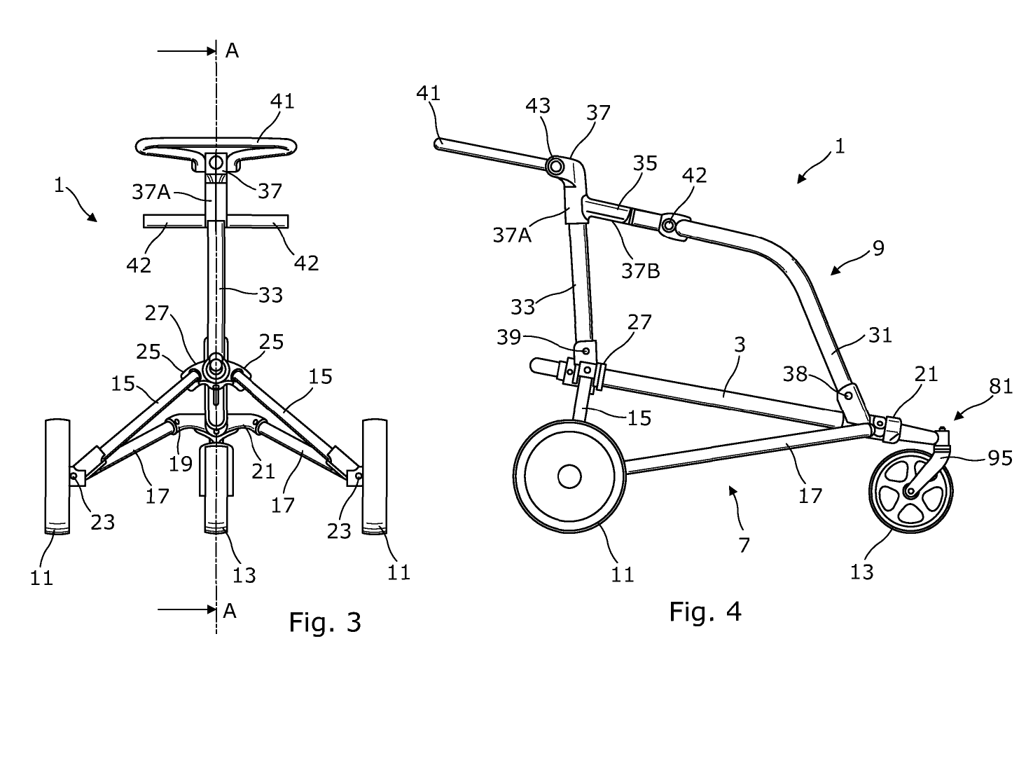

FIG. 3 is a rear view of the trolley of FIGS. 1 and 2;

FIG. 4 is a side view of the trolley of FIGS. 1 to 3;

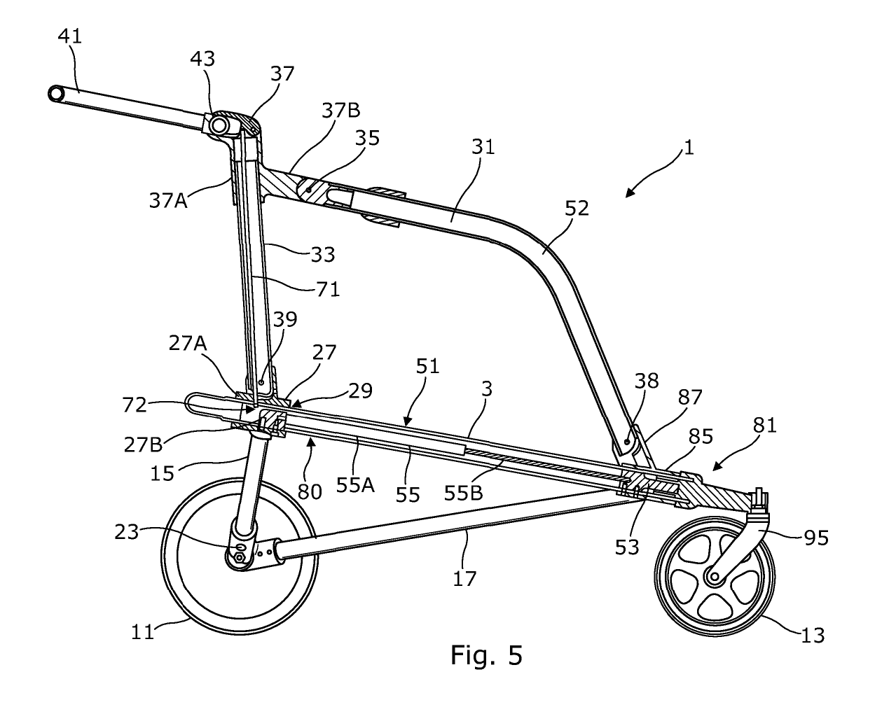

FIG. 5 is a sectional side view taken on line A-A of FIG. 3;

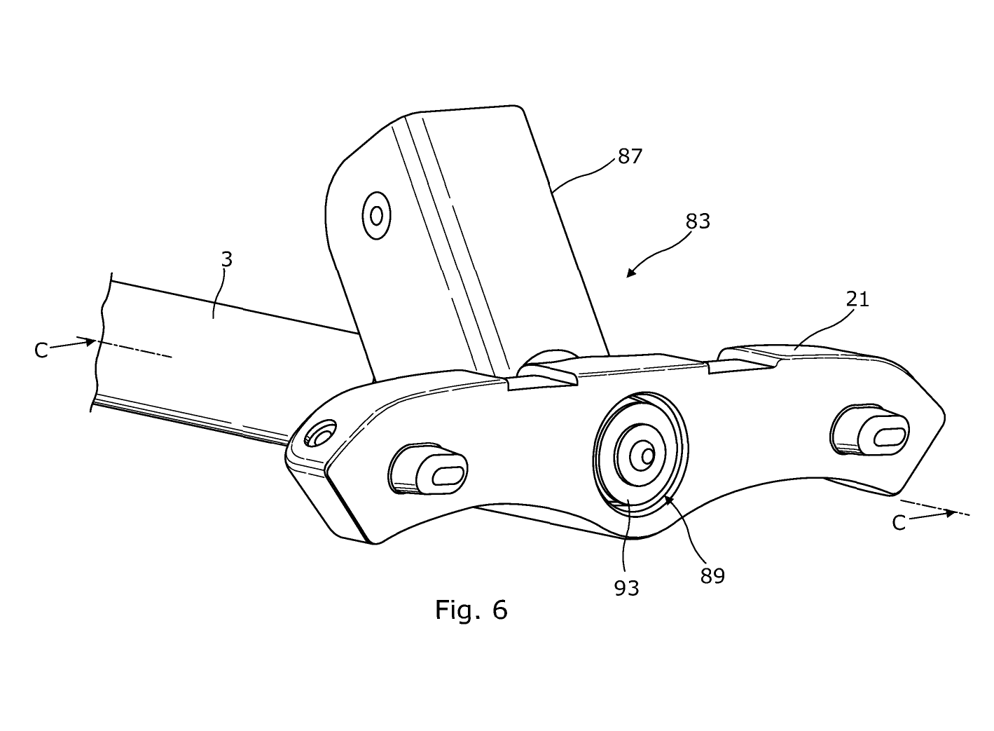

FIG. 6 is an enlarged perspective view of part of a front wheel assembly of the trolley of FIGS. 1 to 5, with the front wheel removed;

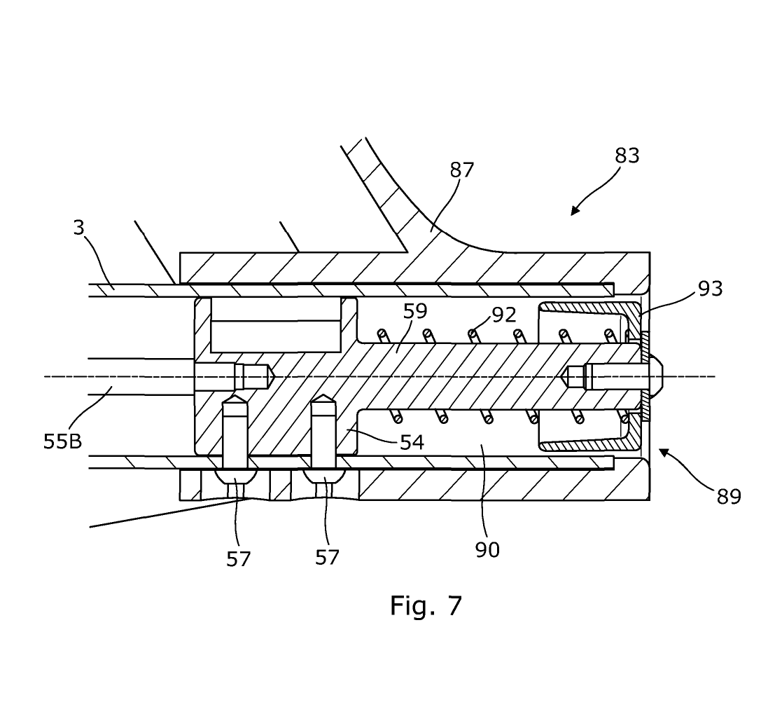

FIG. 7 is a sectional view through line C-C of FIG. 6 with the trolley in an operational condition;

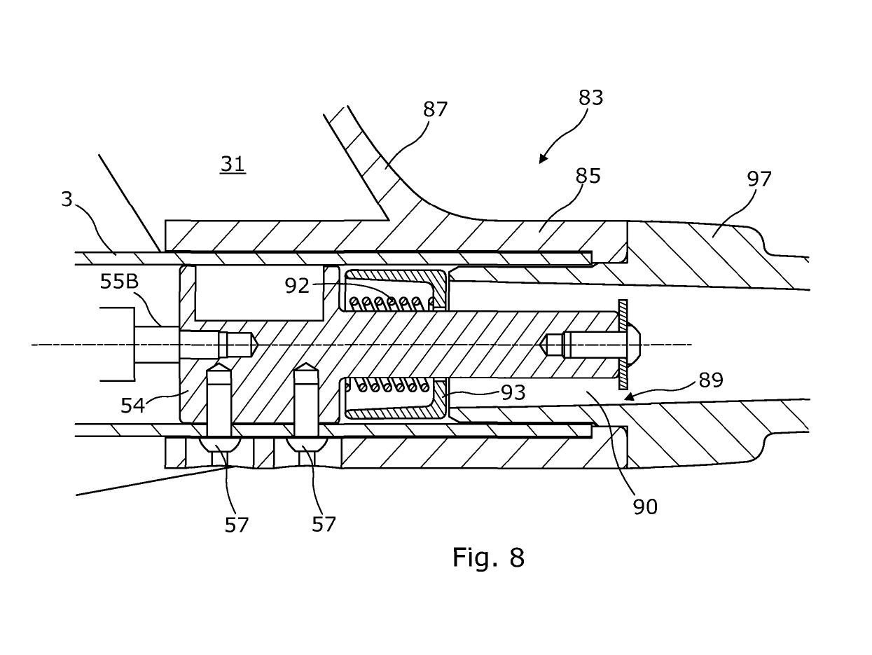

FIG. 8 is a view corresponding to FIG. 7 with the trolley in a partially collapsed condition;

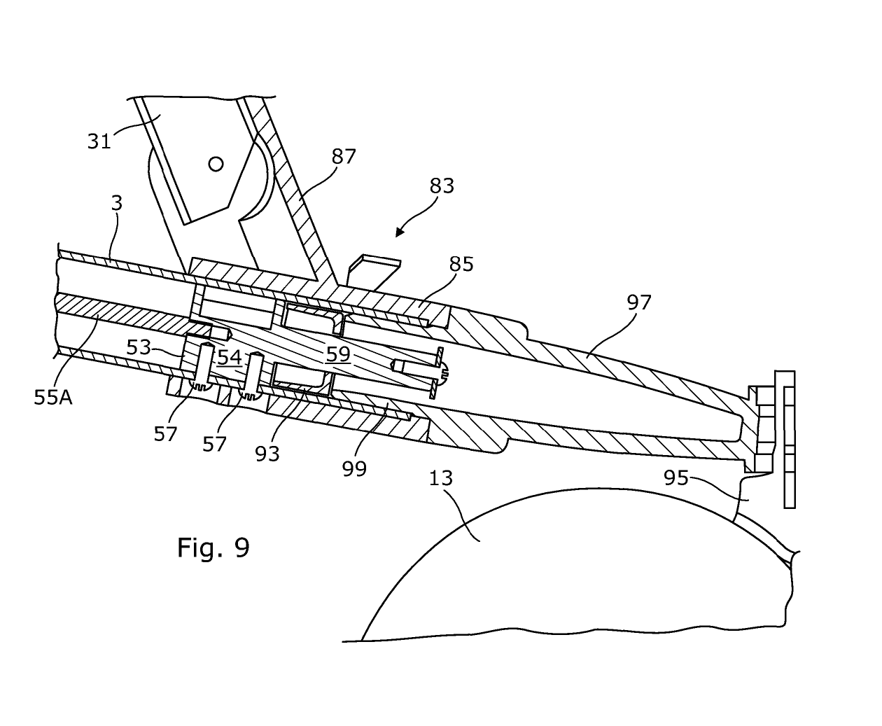

FIG. 9 is a view corresponding to FIG. 8, with the wheel attached

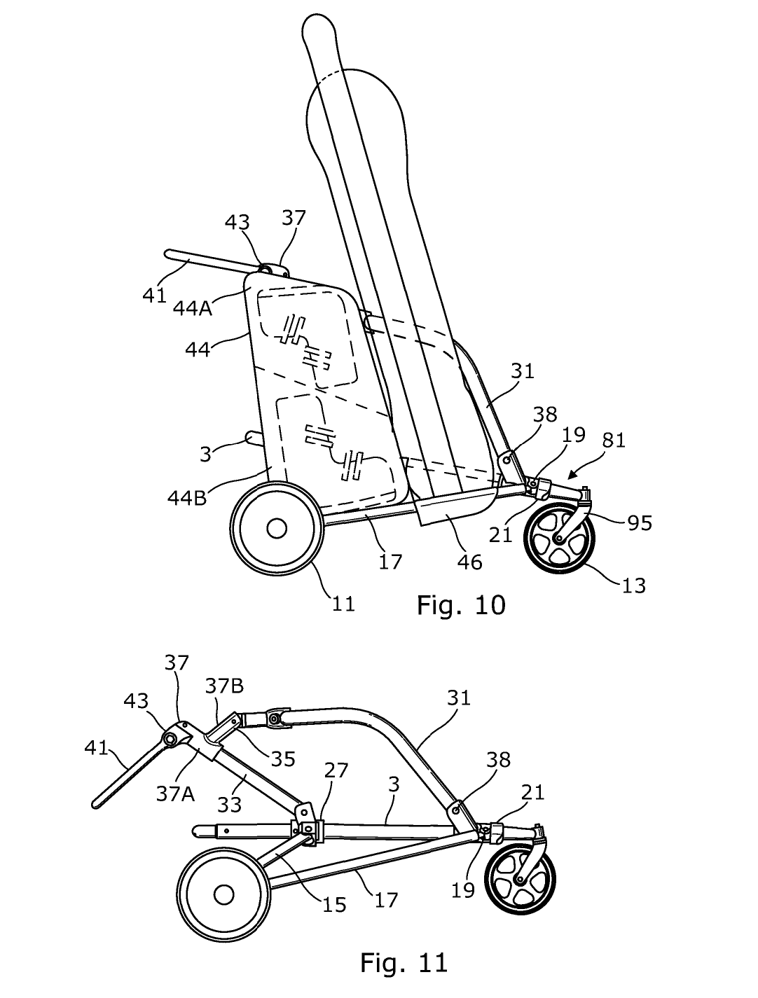

FIG. 10 is a side view of the trolley of FIGS. 1 to 5 with panniers and load carrying platform mounted thereon;

FIG. 11 is a side view of the trolley of FIGS. 1 to 5 in a partially collapsed condition;

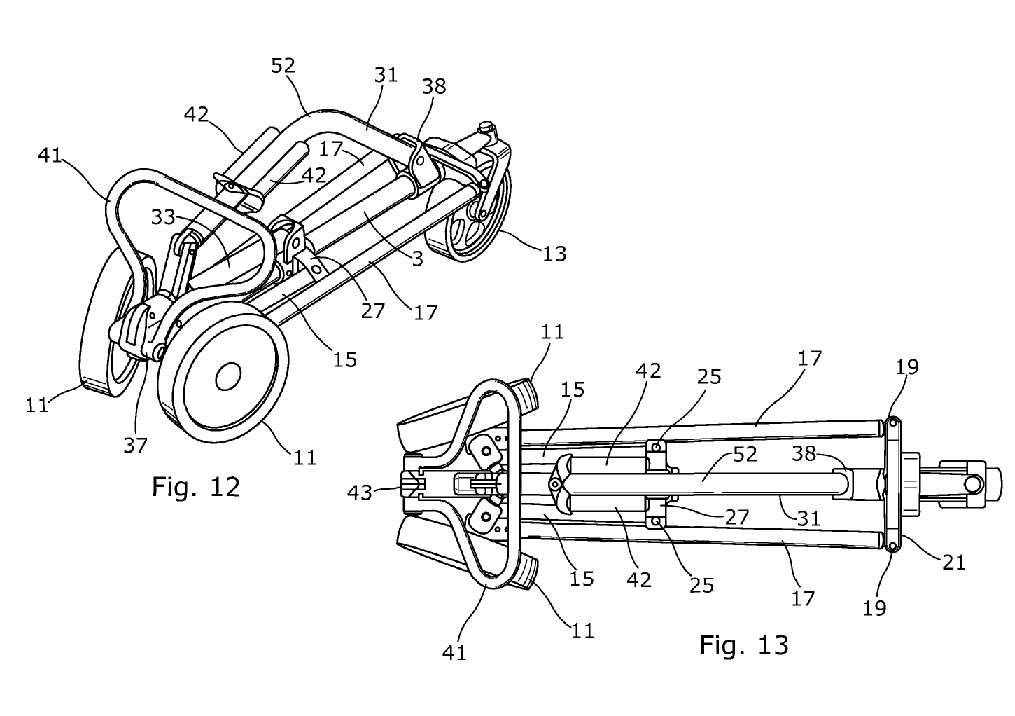

FIG. 12 is a perspective view of the trolley of FIGS. 1 to 5 in a fully collapsed condition;

FIG. 13 is a plan view corresponding to FIG. 12;

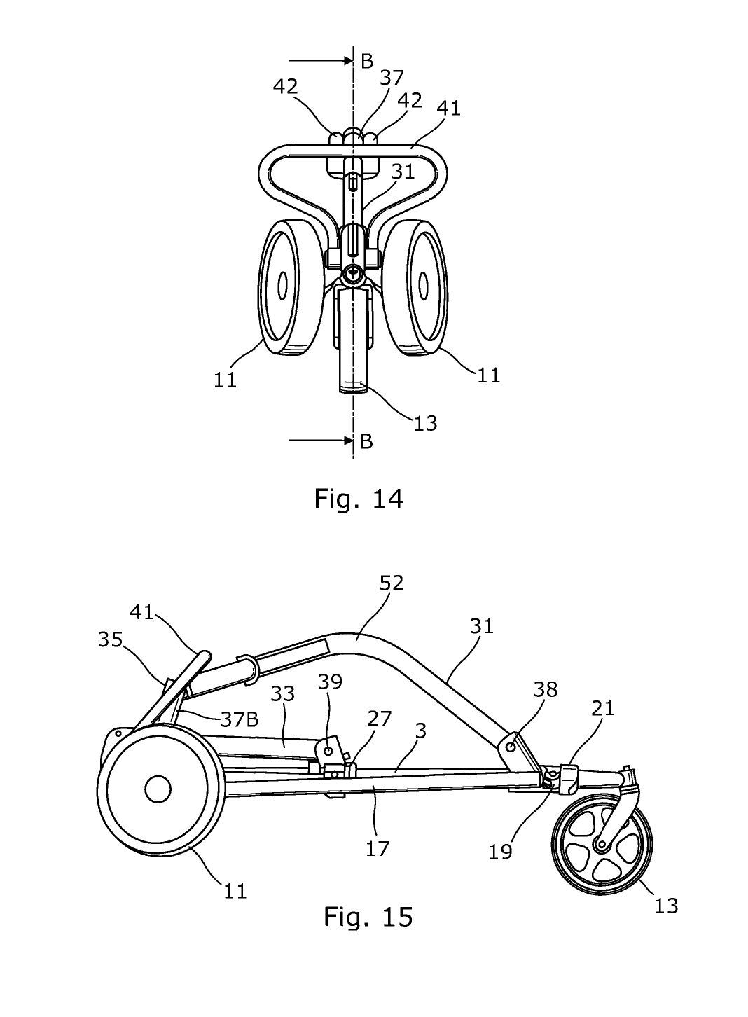

FIG. 14 is a rear view corresponding to FIGS. 12 to 13;

FIG. 15 is a side view corresponding to FIGS. 12 to 14; and

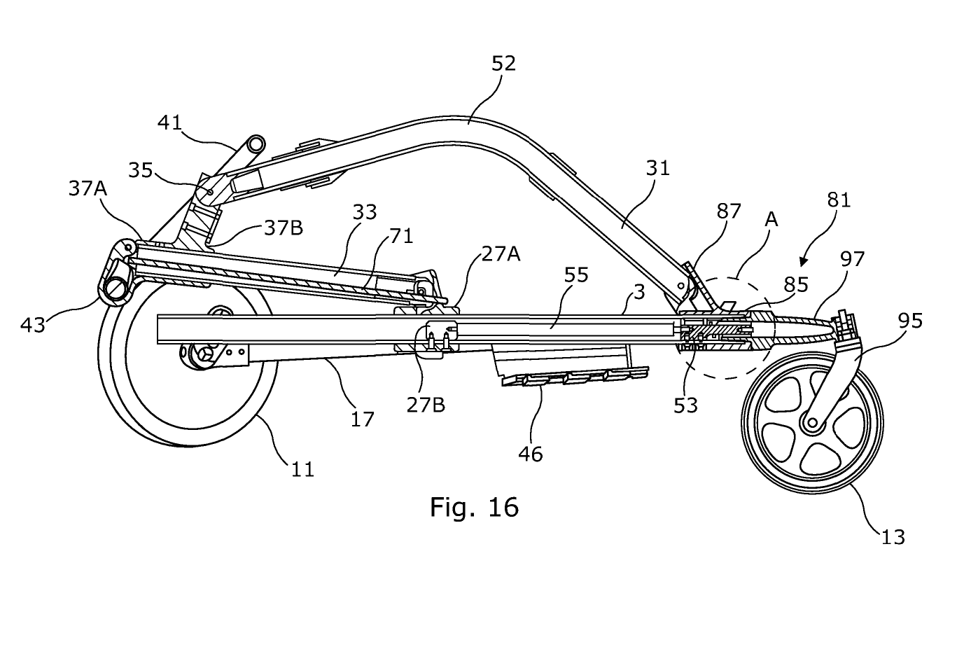

FIG. 16 is a sectional side view taken on line B-B of FIG. 15.

Referring initially to FIGS. 1 to 4, a leisure equipment trolley 1 comprises a tubular base spine 3 extending along the longitudinal axis 5 of the trolley 1, two collapsible wheel carrying wing frames 7 mounted on the spine 3, and a collapsible load support frame 9 also mounted on the spine 3. Each wing frame 7 carries a respective rear wheel 11 of the trolley 1. A single front wheel 13 is provided at the front end of the base spine 3.

Each wing frame 7 is of triangular configuration having a laterally outwardly projecting rear strut 15 extending between the rear of the spine 3 and a rear wheel 11, and a longitudinally extending arm 17 extending forwardly between the strut 15 and the front of the spine 3.

The front end of the arm 17 is pivotally connected 19 to one end of a transverse brace 21 mounted on and extending across the front of the spine 3. The rear end of the arm 17 is pivotally connected 23 to the outer end of the strut 15. The inner end of the strut 15 is pivotally connected 25 to the side of a carriage 27 movably mounted on the spine 3 for movement along the spine 3 towards and away from the brace 21 and front wheel 13.

In this example, the carriage 27 is arranged for sliding movement along the spine 3.

The collapsible load support frame 9 comprises front and rear frame members in the form of front and rear frame tubes 31, 33 pivotally connected together 35 at a handle bracket 37. The front frame tube 31 is of arcuate form, the lower end of which is pivotally mounted 38 at the front of the spine 3, adjacent the brace 21, the upper end of which is pivotally connected 35 to the handle bracket 37. The rear frame tube 33 is substantially straight and extends down from the handle bracket 37 to pivotal mounting 39 on the top of carriage 27. The front and rear frame tubes 31, 33 form a generally ‘n’ shaped support frame 9 when in the operational condition.

The handle bracket 37 comprises a hollow tubular body 37A which receives the upper end of the rear frame tube 33. A lug 37B projects from the front of the tubular body 37A and the upper end of the front frame tube 31 is pivotally mounted thereto. A handle 41 is hingedly mounted 43 to the tubular body 37A for pivotal movement towards and away from the rear frame tube 33. A locking mechanism, such as a latch, ratchet or clamp for example, may be provided so that the handle 41 can be fixed in a desired position and then subsequently released when the trolley 1 is to be collapsed.

Referring additionally to FIGS. 5 to 9, the trolley 1 further comprises an auto-erection actuation mechanism generally indicated 51 operative to move the trolley 1 from the collapsed condition to the operational condition.

The actuation mechanism 51 comprises the movable carriage 27 slidable along the spine 3, a front stop 53 fixed to the front end of the spine 3, and an intermediate actuator 55 which in this example comprises a gas strut.

The carriage 27 is of tubular form and comprises an outer tubular sleeve 27A that defines a through bore 29 that receives the spine 3, and an inner block 27B received inside the spine 3. The outer sleeve 27A and inner block 27B are joined together by a joint that extends through the wall of the spine 3, and in particular, extends through an elongate slot 30 that extends along the underside of the spine 3.

The front stop 53 comprises a cylindrical boss 54 located inside the spine 3, and fixed in place via screws 57 through the wall of the spine 3. A mounting rod 59 extends forwardly from the boss 54 towards the open front end of the spine 3. A front wheel assembly 81 is removably mounted on the mounting rod 59 as further described below.

The gas strut actuator 55 comprises a cylinder 55A of gas, the cylinder 55A being secured to the inner portion 27B of carriage 27. A plunger 55B extends into the cylinder 55A and is secured to a piston (not shown) arranged to move in use through the gas in the cylinder 55A. The distal end of the plunger 55B is secured to the boss 54 of front stop 53.

A latching mechanism is provided to resist the trolley 1 collapsing from the operational condition to the collapsed condition. The latching mechanism in this example comprises a rod 71 that extends through the straight rear frame tube 33 of the support frame 9, the lower end of the rod 71 projecting through an aperture 72 in the spine 3, when the trolley 1 is in the operational condition. The end of the rod 71 thus engages the spine 3 and resists movement of the carriage 27 along the spine 3. To release the latch, the rod 71 is moved upwardly within the straight rear frame tube 33 so that the end of the rod 71 is no longer in the spine aperture 72. The carriage 27 is then free to move along the spine 3. A release mechanism is provided at the handle bracket 37 and may in fact comprise the handle 41 itself, movement of the handle 41 relative to the handle bracket 37 moving the rod 71 within the straight rear frame tube 33.

The front wheel assembly 81 comprises a front mounting bracket 83 comprising a base tube 85 slidably mounted on the front end of the spine 3, and an upwardly inclined mount 87.

The lower end of the curved front frame tube 31 is pivotally mounted 38 on the upwardly inclined mount 87. The mount 87 comprises an elongate channel of ‘n shaped cross-section and is inclined towards the rear of the trolley 1. The end of the front frame tube 31 is partially received in the channel of the mount 87.

The cross brace 21 extends from, and is integral with, the front of the base tube 85. The cross brace 21 is provided with a central mounting aperture 89 coaxial with the base tube 85 and spine 3. The aperture 89 and the forward facing part of the base tube 85 together form a mounting socket 90.

The front stop 53 is fixedly mounted in the front end of the spine 3, with the mounting rod 59 extending forwardly within the socket 90, the tip of the rod 59 being aligned with the mounting aperture 89 of the cross brace 21.

A spring loaded end cap 93 is provided in the socket 90, mounted on the mounting rod 59, and is biased, for example by a compression spring 92 from a retracted position in which the end cap 93 is adjacent the boss 54 of front stop 53, to a closed position in which the end cap 93 is positioned in the mounting aperture 89 of the cross brace 21 to close the aperture 89 and resist ingress of foreign bodies into the socket 90.

The front wheel assembly 81 further comprises a wheel mount 97 on which the front wheel 13 is mounted via caster 95. The wheel mount 97 comprises a rearwardly directed plug 99 which is removably received in the socket 90 of the front mounting bracket 83 to removably mount the front wheel 13 to the spine 3. As the plug 99 is inserted into the socket 90, the tip of the plug 99 engages and forces the end cap 93 to the retracted position, against the bias of the end cap spring.

When the trolley 1 is in the collapsed condition the plug 99 may be pulled from the socket 90 to remove the front wheel 13 from the trolley 1 for storage. A clip or the like may be provided on another part of the trolley 1 to releasably clip the removed front wheel 13 (and wheel mount 97) to the trolley 1, when in the collapsed condition.

Referring additionally to FIG. 10, the trolley 1 is provided with bespoke luggage adapted to be removably mounted on the trolley 1.

In this example, the bespoke luggage is designed for carrying snow equipment.

Load carrying means is provided on the trolley on which the bespoke luggage is attached. The load carrying means in this example comprises a pair of opposed mounting bars 42 extending from either side of the curved front frame tube 31. The bars 42 are pivotally mounted on front frame tube 31 so as to be retractable.

The bespoke luggage comprises a pair of semi-rigid panniers 44 each adapted to be mounted on a respective bracket (not shown) attached to the curved front frame tube 31 and positioned such that the bespoke luggage hangs down from the respective bracket. Each pannier 44 is portioned 46 into two compartments 44A, 44B, each dimensioned to receive a pair of ski or snowboard boots, or other ski or snowboard equipment as required. For example goggles, helmets, extra warm clothing, spare socks, a first aid kit, and food and drink may be stored in the panniers, as required.

The load carrying means further comprises a ski/snowboard support platform 46 that clips onto the spine 3 and the outer arms 17 of the wing frames 7. The platform 46 is formed with tubular recesses dimensioned to receive the spine 3 and wing frame arms 17. Skis and/or snow-boards can be placed with their ends resting on the platform 46, so as to lean against the mounting bars 42. Retaining means in the form of a bungee, retaining strap or loop may be provided to retain the skis/snowboards against the mounting bars 42.

Referring additionally to FIGS. 11 to 16, the trolley 1 is collapsible from the operational condition of FIGS. 1 to 10, to a partially collapsed condition of FIG. 11, into a fully collapsed condition of FIGS. 12 to 16. In the operational condition, the support frame 9 is upstanding from the spine 3, and the wing frames 7 extend transversely from the spine 3 such that the rear wheels are distal from the spine 3. In the collapsed condition, the first and rear frame tubes 31, 33 of the support frame 9 are adjacent the spine 3 with the rear frame tube 33 folded underneath the front frame tube 31 and adjacent the spine 3. The wing frames 7 are, and thus the rear wheels, are adjacent the spine 3 with the rear struts 15 folded against the spine 3, and the arms 17 folded adjacent the rear struts 15.

The trolley 1 is moved between the collapsed and operational conditions by moving the carriage 27 along the spine 3, towards and away from the front wheel 13.

As the carriage 27 is moved towards the brace 21 and front wheel 13, this pulls the inner end of each wing frame strut 15 with the carriage 27, each strut 15 pivoting relative to its respective arm 17. Further movement of the carriage 27 pulls each strut 15, and the rear wheel end of each arm 17 towards the spine 3 to collapse each wing frame 7. The wing frames 7 thus collapse and fold into the spine 3.

When the carriage 27 is moved towards the brace 21 and front wheel 13, the lower end of the straight rear frame tube 33 of the support frame 9 is also pulled with the carriage 27 and pivots about pivot 39. The straight rear frame tube 33 also pivots about the pivot 35, so as to fold underneath the arcuate front frame tube 31. This pulls the arcuate front frame tube 31 down towards the spine 3 such that the straight rear frame tube 33 is adjacent and substantially parallel with the spine 3, with the curved front frame tube 31 arcing over the top of the spine 3 and the straight rear frame tube 33. When in the collapsed condition, the middle of the arcuate front frame tube 31 comprises a carrying handle 52 to enable the collapsed trolley 3 to be easily picked up and carried so as, for example, to be stowed in a store room, or a vehicle.

When the trolley 1 is in the operational condition, the user can collapse the trolley by releasing the rod 71 from the spine aperture 72 either by pivoting the handle 41 relative to the handle bracket 37, or via a separate clip, catch or button at the handle bracket 37. Downward pressure on the straight rear frame tube 33 applied via the handle 41 initiates movement of the carriage 27 along the spine 3, towards the front wheel 13. This movement is against the pressure applied between the carriage 27 and the front stop 53 by the gas strut 55. Further downward pressure on the handle 41 and straight rear frame tube 33 continues to move the carriage 27 along the spine 3, and the force required to achieve this movement reduces the further along the spine 3 the carriage 27 moves. This is because the lever acting on the carriage 27 increases as the carriage 27 moves further away from the pivot point between the curved front frame tube 31 and the straight rear frame tube 33 of the support frame 9. Eventually the cylinder 55A of the gas strut actuator 55 abuts the front stop 53 and the trolley 1 is in the fully collapsed condition with the straight rear frame tube 33 substantially parallel with the spine 3, and the curved front frame tube 31 adjacent the straight rear frame tube 33 and the spine 3. The movement of the carriage 27 also collapses the wing frames 7, as described above.

A catch or other locking mechanism may be provided to lock the trolley 1 in the collapsed condition, and in particular to lock the carriage 27 adjacent the front stop 53.

To erect the trolley 1, the catch or locking mechanism is first released. The gas strut actuator 55 applies a force between the front stop 53 and the carriage 27 which biases the carriage 27 away from the front stop 53 and the front wheel 13. This biasing force moves the carriage 27 along the spine 3, and thus moves the straight rear frame tube 33 from the substantially horizontal collapsed position to the substantially vertical position. This movement of the straight rear frame tube 33 also moves the front frame tube 31 away from the spine 3 until the support frame 9 reaches the operational condition. The user may apply upward movement to the handle 41 to supplement the force applied by the gas strut actuator 55.

The movement of the carriage 27 away from the front wheel 13 also moves the wing frames 7 to the operational condition. In particular the carriage 27 forces the inner ends of the rear struts 15 away from the front wheel 13, towards the rear of the trolley 1. This movement forces the struts 15 from being parallel with the spine 3 to being substantially perpendicular to the spine 3. As the angle between the struts 15 and spine 3 increases, this forces the arms 17 and the rear wheels laterally away from the spine 3 until the rear wheels are distal from the spine 3.

The main components of the trolley 1, namely the spine 3, wing frames 7, support frame 9, may be formed from any suitable material such as metal or metal alloy material, a plastics material, or a composite material. Likewise the components that link these main components together, namely the handle bracket 37, the carriage 27, the front wheel assembly 81 can be formed from any suitable material such as a metal or metal alloy material, a plastics material, or a composite material.

The load support means, and the bespoke luggage may be adapted to suit the required use of the trolley 1, and indeed the bespoke luggage may be modular so that the luggage can be changed to suit the use. For example the luggage may comprise a first set of luggage comprising the snow equipment panniers and platform, and a further set of luggage designed for a different purpose.

The trolley 1, and load support means may be put to any required use, the above described uses being examples only.

Although the invention has been described in terms of certain preferred embodiments, it will be apparent to those of ordinary skill in the art that modifications and improvements can be made to the inventive concepts herein without departing from the scope of the invention. The embodiments described and shown herein are merely illustrative of the inventive concepts and should not be interpreted as limiting the scope of the invention.

By snow equipment we include at least one of: skis, snowboards, snowblades, ski boots, snow boots, snowboard boots, snow shoes, ski poles, and any other ski or snowboard equipment.

1. A leisure equipment trolley comprising an elongate base spine aligned with the longitudinal axis of the trolley, at least two rear wheels and one front wheel being mounted on the base spine, and load support means on which a load can be mounted in use, the trolley further comprising a collapsible support frame being mounted on the spine and movable from a collapsed condition wherein the support frame is adjacent the spine to an operational condition in which the support frame is upstanding from the spine, the support frame comprising two elongate frame members, first ends of which are pivotally connected together, the other end of the first elongate frame member being pivotally mounted to the base spine, the other end of the second elongate frame member being movably mounted on the base spine so as to be moveable along the spine towards and away from the pivotal mounting of the first elongate frame member on the spine such that the support frame can be moved from the collapsed condition to the operational condition and vice versa.

2. The trolley of claim 1 wherein an auto-erect actuator is provided one end of which is fixed to the spine, the other end of which is connected to the support frame, the actuator being operative to exert a driving force on the support frame to drive the second elongate frame member away from the pivot mounting of the front frame tube to raise the support frame to the operational condition.

3. The trolley of claim 1 wherein the second elongate frame member is mounted on a carriage, the carriage being movably mounted on the base spine for movement along the spine.

4. The trolley of claim 3 wherein the carriage is slidably mounted on the spine.

5. The trolley of claim 1 wherein the first and second elongate frame members together form a generally ‘n’ shaped support frame, when in the operational condition.

6. The trolley of claim 5 wherein at least one of the elongate frame members is arcuate.

7. The trolley of claim 5 wherein the first elongate frame member is arcuate, the second elongate frame member being substantially straight.

8. The trolley of claim 5 wherein the apex of the ‘n’ shaped support frame comprises a carrying handle suitable for a user to pick up the trolley, when in the collapsed condition.

9. The trolley of claim 1 wherein the second elongate frame member is arranged to be positioned between the spine and the first elongate frame member, when in the collapsed condition.

10. The trolley of claim 1 wherein the support frame, when in the operational condition, is upstanding from the centre of the trolley, that is the longitudinal axis of the support frame is coplanar with the longitudinal axis of the trolley.

11. The trolley of claim 2 wherein the auto-erect actuator is operative to exert a driving force in the form of a biasing force operative to bias the second elongate frame member away from the pivot mounting of the front frame tube.

12. The trolley of claim 2 wherein the auto-erect actuator comprises a gas strut.

13. The trolley of claim 1 wherein each rear wheel is mounted on a respective wing frame, each wing frame extending from a respective side of the spine.

14. The trolley of claim 13 wherein each wing frame is movably mounted on the spine so as to be movable from a collapsed condition in which each wing frame and rear wheel are adjacent the spine, to an operational condition in which each wing frame extends laterally away from the spine such that each rear wheel is laterally spaced from the spine.

15. The trolley of claim 13 wherein each wing frame comprises a longitudinally extending arm pivotally mounted to the spine, and a laterally extending strut, one end of which is connected to the arm, the other end of which is movably mounted on the base spine so as to be moveable along the spine towards and away from the pivotal mounting of the front frame tube on the spine to move each wing frame from the collapsed condition to the operational condition and vice versa.

16. The trolley of claim 13 as dependent on claim 2 wherein the auto-erect actuator is operative to move the wing frames from the collapsed condition to the expanded condition.

17. The trolley of claim 13 wherein the other end of each laterally extending strut is connected to the second elongate frame member of the support frame.

18. The trolley of claim 17 wherein the other end of each laterally extending strut is connected to the carriage.

19. The trolley of claim 1 wherein the load support means is provided at the longitudinal axis of the trolley.

20. The trolley of claim 1 wherein the load support means is retractable, when the trolley is in the collapsed condition.

21. The trolley of claim 19 wherein the load support means comprises an upper mounting bracket provided on the support frame, a pannier being provided and being adapted to be mounted on the mounting bracket so as to hang down from the bracket.

22. The trolley of claim 21 wherein the bracket is mounted on the support frame.

23. The trolley of claim 21 wherein the pannier is a semi-rigid bag, that is, of a flexible material provided with a reinforcing structure.

24. The trolley of claim 23 wherein the pannier is partitioned so as to form at least two separate compartments.

25. The trolley of claim 24 wherein the pannier comprises an inclined partition extending between front and rear walls of the pannier such that the pannier is provided with an upper and a lower compartment.

26. The trolley of claim 1 wherein the load support means comprises a load carrying platform adapted to be mounted on the spine.

27. The trolley of claim 1 wherein the load support means is provided with a load retainer operative to retain the load on the load support means.

28. The trolley of claim 1 wherein a handle is provided at the rear of the support frame to enable the trolley to be pushed in use.

29. The trolley of claim 28 wherein the handle is retractable.

30. The trolley of claim 29 wherein the handle is pivotally mounted on the second elongate frame member of the support frame so as to be movable from an operational condition in which the handle projects from the support frame, to a collapsed condition in which the handle is adjacent the support frame.

31. The trolley of claim 1 wherein a latch is provided to lock the trolley in the operational condition.

32. The trolley of claim 31 wherein latch release means are provided at the handle to release the latch to enable the trolley to be collapsed into the collapsed condition.

33. The trolley of claim 32 wherein the latch release means is operated by moving the handle relative to the support frame.

34. The trolley of claim 32 wherein the latch release means comprises a rod that projects from the support frame, one end of the rod engaging the spine when the trolley is in the operational condition.

35. The trolley of claim 1 wherein the front wheel is removably mounted on the spine.

36. The trolley of claim 35 wherein the front wheel comprises a wheel mount comprising a mounting plug received in a mounting socket on the spine to mount the front wheel on the spine.

37. The trolley of claim 36 wherein the mounting socket is provided with a spring loaded movable closure operative to automatically close the mounting socket when the mounting plug is removed from the mounting socket, so as to resist ingress of foreign bodies in the mounting socket, when the wheel is removed.

38. The trolley of claim 1 wherein the front wheel is steerably mounted on the spine.

39. A snow equipment trolley comprising an elongate base spine aligned with the longitudinal axis of the trolley, at least two rear wheels and one front wheel being mounted on the base spine, and snow equipment support means for carrying snow equipment in use, the snow equipment support means comprising a mounting lug on the support frame, a pannier for at least one of ski boots, snow boots, snowboard boots, or other ski or snowboard equipment, the pannier being adapted to be mounted on the mounting lug so as to hang from the mounting lug, and a load platform mounted on the spine for supporting skis and/or snowboards, the trolley further comprising a collapsible support frame being mounted on the spine and movable from a collapsed condition wherein the support frame is adjacent the spine to an operational condition in which the support frame is upstanding from the spine, the support frame comprising two elongate frame members first ends of which are pivotally connected together, the other end of the first elongate frame member being pivotally mounted to the base spine, the other end of the second elongate frame member being movably mounted on the base spine so as to be moveable along the spine towards and away from the pivotal mounting of the first elongate frame member on the spine such that the support frame can be moved from the collapsed condition to the operational condition and vice versa

40. The snow equipment trolley of claim 39 further comprising an auto-erect actuator being provided one end of which is fixed to the spine, the other end of which is connected to the support frame, the actuator being operative to exert a driving force on the support frame to drive the second elongate frame member away from the pivot mounting of the front frame tube to raise the support frame to the operational condition.

41. Removable luggage for mounting on the trolley of claim 1.

42. (canceled)

43. A snow equipment trolley comprising a base frame on which are mounted two transversely spaced rear wheels and a steerable front wheel, a support frame upstanding from the base frame, at least one of the base frame and the support frame being provided with ski equipment support means on which ski equipment can be supported in use of the trolley.
